(19) United States
(12) Patent Application Publication
(10) Pub. No.: US 2018/0297108 A1
(43) Pub. Date: Oct. 18, 2018

(54) Method and Device for Producing a Ring-Shaped Formed Part

(71) Applicant: Hatebur Umformmaschinen AG, Reinach (CH)

(72) Inventors: Andreas MATT, Murg (DE); Patrick STEMMELIN, Moernach (FR); Olivier RITTER, Village-Neuf (FR)

(21) Appl. No.: 15/766,149

(22) PCT Filed: Oct. 10, 2016
(86) PCT No.: PCT/EP2016/074120

§ 371 Date: Apr. 5, 2018

(30) Foreign Application Priority Data
Oct. 14, 2015 (CH) 01486/15

(51) Int. Cl. B21K 1/76; B21K 1/04; F16C 33/64

(52) U.S. Cl. CPC B21K 1/761; B21D 31/04; F16C 33/64; B21K 1/04

(57) ABSTRACT

In a method for producing a ring-shaped formed part, by means of a forming device first of all a ring of smaller cross-sectional dimensions than the formed part being produced is formed from a blank in various forming stages. The ring is then expanded to the cross-sectional dimensions of the formed part being produced. The expansion of the ring is effected in an expansion stage of the forming device by means of a die and an expansion punch, where the ring is arranged in the die and the expansion punch is pressed into the ring in the axial direction and thereby expands the ring. The expansion of the ring is effected in two or more steps. In that way, excessive material stresses and any resulting material damage can be avoided.

The invention relates to a method and a device for producing a ring-shaped formed part in accordance with the preamble of patent claim 1 and the preamble of patent claim 9, respectively.

A known method for producing rolling bearing rings lies in first producing a pair of rings by means of hot-forming in a forming device, one of which rings forms the internal ring and the other of which forms the external ring of a rolling bearing. One or both of the rings is/are expanded by a certain amount, for example in order to create space for the balls or rollers to be arranged between the rings.

The expansion of the rings is generally effected outside the forming device in separate devices, for example in a ring rolling device or by means of cold calibration. In addition to requiring additional devices, that kind of ring expansion also requires interfaces between the devices involved and entails a relatively large amount of handling work.

U.S. Pat. No. 6,065,322 A discloses in that regard methods and devices in which, in an expansion stage of the forming device, a ring formed in the forming device is expanded to the cross-sectional dimensions of the formed part being produced by means of a die and by means of at least one expansion punch, wherein the ring is arranged in the die and in one step the expansion punch is pressed into the ring in the axial direction and thereby expands the ring. During that procedure the material can be subjected to high stresses, which can result in material damage.

Against that background, the problem underlying the invention is to improve a method and a corresponding device for producing a ring-shaped formed part so that the expansion process takes place inside the forming device, while excessive material stresses are avoided.

That problem is solved by the method according to the invention and the device according to the invention, as defined in independent patent claim 1 and in independent patent claim 9, respectively. Especially advantageous developments and embodiments of the invention will be apparent from the respective dependent patent claims.

In respect of the method, the core of the invention lies in the following: in a method for producing a ring-shaped formed part, by means of a forming device a ring of smaller cross-sectional dimensions than the formed part being produced is formed from a blank and then, in an expansion stage of the forming device, the resulting ring is expanded to the cross-sectional dimensions of the formed part being produced by means of at least one die and by means of at least one expansion punch, wherein the ring is arranged in the die and the expansion punch is pressed into the ring in the axial direction and thereby expands the ring. According to the invention, the expansion of the ring is effected in two or more steps.

Because the expansion is carried out in an appropriately configured forming stage or expansion stage inside the forming device it is possible to produce virtually finished formed parts (expanded rings) inside the forming device. The processing steps for the expansion that are otherwise customarily carried out outside the device are entirely unnecessary. Because the expansion of the ring is effected in two or more steps, excessive material stresses and any resulting material damage can be avoided.

It is advantageous that the length of the formed part is altered at most insignificantly by the expansion.

Expediently an expansion punch is used which has at least two portions of different cross-sectional dimensions and a transition portion between each two such portions. Such an expansion punch enables the expansion process to be carried out relatively easily. Advantageously the expansion punch can have clearance gaps or angles, especially in order to reduce friction.

Expediently a die having a die chamber for receiving the ring is used, wherein the cross-sectional dimensions of the die chamber correspond to the external cross-sectional dimensions of the formed part being produced. This guarantees the dimensional accuracy of the formed part being produced.

Advantageously the expansion of the ring is effected by means of two or more dies of different dimensions and accordingly by means of two or more expansion punches of different dimensions. This allows optimum adaptation to the particular materials used.

Alternatively the expansion of the ring can also be effected by means of an expansion punch which is doubly or multiply stepped in its cross-sectional dimensions.

Advantageously the expansion is followed by a coining step, wherein the expanded ring is acted upon in the die by pressure in the axial direction by means of a portion of the expansion punch or by means of a separate coining punch, possibly in a further forming stage. The coining step ensures that the die chamber is filled without gaps, thus further improving the dimensional accuracy of the finished expanded ring or the formed part being produced. Moreover, the end faces of the ring or of the formed part being produced are smoothed, so that flawless straight end faces are obtained.

Advantageously the formed part being produced is a rolling bearing ring. The forming of the blank into the ring is advantageously effected by hot-forming at temperatures of 700° C. and above.

In respect of the device, the core of the invention lies in the following: a device for producing a ring-shaped formed part comprises a forming device having forming stages which are configured to form a ring from a blank. The forming device comprises an expansion stage which has at least one die for receiving the ring and at least one expansion punch which is arranged to be pressed axially into the ring located in the die, the ring being expandable in the die by the expansion punch. According to the invention, the expansion stage is configured to carry out the expansion of the ring in two or more steps.

Advantageously the expansion punch has at least two portions of different cross-sectional dimensions and a transition portion between each two such portions.

Advantageously the expansion stage has two or more dies of different dimensions and accordingly two or more expansion punches of different dimensions.

In the case of two or more dies, the expansion stage is to be understood as comprising two or more sub-expansion stages each having a die and an associated expansion punch.

The invention is described in greater detail below with reference to exemplary embodiments shown in the drawing, wherein:

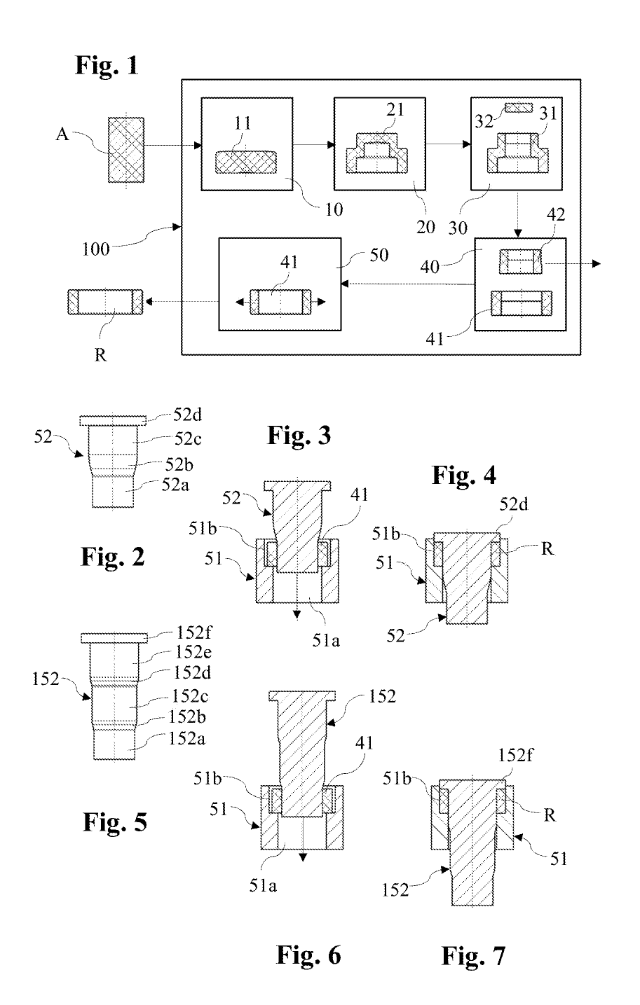

FIG. 1—is a block diagram illustrating an exemplary embodiment of a forming device according to the invention;

FIG. 2-4—show a variant of an expansion stage in various operating phases;

FIG. 5-7—show a first variant of an expansion stage of the forming device in accordance with the invention in various operating phases;

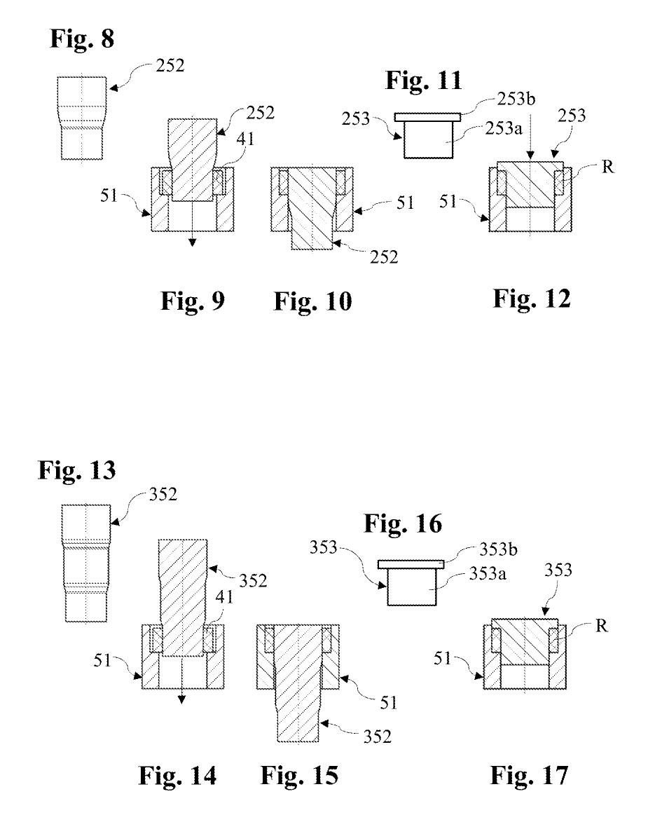

FIG. 8-12—show a further variant of an expansion stage in various operating phases;

FIG. 13-17—show a second variant of an expansion stage of the forming device in accordance with the invention in various operating phases;

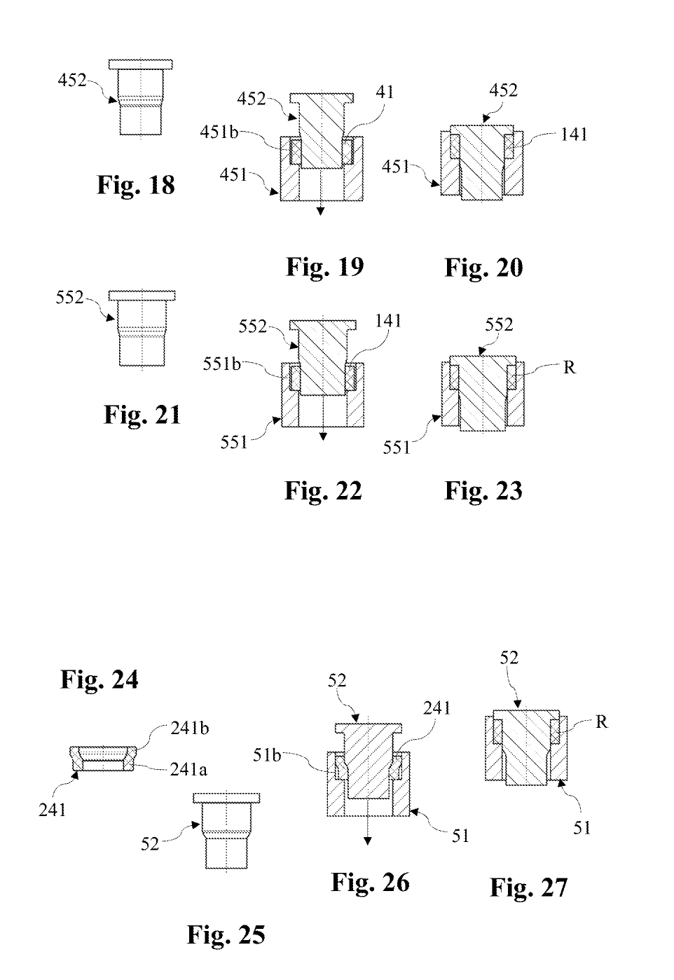

FIG. 18-23—show a third variant of an expansion stage of the forming device in accordance with the invention in various operating phases and

FIG. 24-27—show a further variant of an expansion stage in various operating phases.

The following observations apply in respect of the description which follows: where, for the purpose of clarity of the drawings, reference signs are included in a Figure but are not mentioned in the directly associated part of the description, reference should be made to the explanation of those reference signs in the preceding or subsequent parts of the description. Conversely, to avoid overcomplication of the drawings, reference signs that are less relevant for immediate understanding are not included in all Figures. In that case, reference should be made to the other Figures.

The diagrammatic overview in FIG. 1 shows the function blocks or stages of the forming device according to the invention that are relevant to the understanding of the present invention. The forming device, indicated as a whole by reference sign 100, comprises four forming stages 10, 20, 30 and 40 and an expansion stage 50 which can comprise a plurality of sub-expansion stages. In the first forming stage 10, a blank A, for example a length of a rod material, is supplied and formed into a disc-shaped workpiece 11. In the second forming stage 20, the disc-shaped workpiece is formed into a substantially cup-shaped workpiece 21. In the third forming stage 30, a disc 32 is punched out of the cup-shaped workpiece, so that a ring-shaped workpiece 31 having stepped internal and external diameters is formed. In the fourth forming stage 40, the stepped ring-shaped workpiece is divided into a pair of rings 41 and 42, the internal diameter of the larger ring 41 corresponding to the external diameter of the smaller ring 42. The smaller ring 42 then already has its finished form and is discharged from the forming device. The larger ring 41 is expanded further in expansion stage 50, so that finally its internal diameter is larger by a desired amount than the external diameter of the smaller ring 42. The finished expanded ring constitutes the formed part being produced and is indicated by reference sign R.

The production of the pair of rings 41 and 42 from a length of material A in various forming stages of a forming device corresponds to the prior art and therefore requires no further explanation. The invention relates primarily to the way in which the ring 41 is expanded to form the finished formed part R and to the configuration of the expansion stage 50 of the forming device required for that purpose. This is described in detail below with reference to various exemplary variants.

An important aspect of the invention lies in the fact that the expansion of the ring 41 takes place still inside the forming device 100 in the special expansion stage 50 provided for that purpose, more specifically by means of a die and an expansion punch, wherein the ring 41 being expanded is introduced into the die and the expansion punch is pressed axially through the ring and thereby expands the ring. Because that expansion is carried out in an appropriately configured forming stage or expansion stage inside the forming device it is possible to produce virtually finished formed parts (expanded rings) inside the forming device. The processing steps for the expansion that are otherwise usually carried out outside the device are entirely unnecessary.

FIGS. 2 to 4 illustrate the simplest variant of an expansion operation using an expansion punch 52. A ring-shaped die 51 comprises an axial through-opening 51a and a die chamber 51b, the diameter of which is slightly larger than the external diameter of the ring 41 and corresponds to the desired external diameter of the finished expanded ring or the formed part being produced. The height of the die chamber measured in the axial direction is slightly greater than the corresponding dimension of the ring 41 being expanded. The diameter of the through-opening 51a corresponds to the desired internal diameter of the finished expanded ring. The expansion punch, indicated as a whole by reference sign 52, comprises a first cylindrical portion 52a, a conical portion 52b, a second cylindrical portion 52c and a third cylindrical portion 52d. The diameter of the first cylindrical portion 52a is slightly smaller than the internal diameter of the ring 41 being expanded. The diameter of the second cylindrical portion 52c corresponds to the desired internal diameter of the finished expanded ring. The diameter of the third cylindrical portion 52d is slightly smaller than the diameter of the die chamber 51b. The cylindrical portions 52a and 52c are portions of constant cross-sectional dimensions; the conical portion forms a transition portion between the two portions of constant cross-sectional dimensions.

FIG. 3 shows the die 51 with the ring 41 being expanded inserted in the die chamber 51b and the expansion punch 52 in a position in which only the first cylindrical portion 52a has been inserted into the ring 41. By means of a drive (not shown), which is typically a mechanical drive, the expansion punch 52 is then pressed (in the axial direction) fully into the ring 41 until it finally assumes the position shown in FIG. 4, the ring 41 thereby being expanded to its final form. The finished expanded ring is indicated by reference sign R in FIG. 4. The third cylindrical portion 52d of the expansion punch 52 presses with its ring-shaped end face onto the expanded ring R and ensures that the die chamber 51b is filled without gaps, so that the dimensional accuracy of the finished expanded ring R is achieved. That operation is referred to here and hereinbelow as “coining”.

Expansion in one step using such an expansion punch 52 alone can lead to high material stresses and is therefore not ideal in many cases. According to the invention the expansion is therefore carried out in two or more steps, as described below.

It should also be added that in the context of the description of the illustrated embodiments, it has been assumed for reasons of clarity that the rings being produced have circular cross-sections, which is the case that is most common in practice. Accordingly, the cross-sectional dimensions of the rings, of the die and of the expansion punch are given by internal and external diameters. Expansion accordingly means an enlargement of the internal and external diameters. However, the invention is not limited to the production of rings having circular cross-sections. In the case of other cross-sectional shapes (for example triangular or polygonal), internal and external cross-sectional dimensions analogously take the place of internal and external diameters. Expansion in that case means an enlargement of the internal and external cross-sectional dimensions. It will be understood that the die and the expansion punch then have appropriately adapted internal and external cross-sectional dimensions. The cross-sectional dimensions of the die relate only to the effective cross-section, but lead-in chamfers or clearance gaps may be present.

FIGS. 5 to 7 illustrate a variant of the method in which the expansion of the ring 41 is effected in two steps. The die 51 has the same configuration as in the variant of FIGS. 2 to 4. An expansion punch 152 is multiply stepped and has a first cylindrical portion 152a, a first conical portion 152b, a second cylindrical portion 152c, a second conical portion 152d, a third cylindrical portion 152e and a fourth cylindrical portion 152f. The diameter of the first cylindrical portion 152a is slightly smaller than the internal diameter of the ring 41 being expanded. The diameter of the third cylindrical portion 152e corresponds to the desired internal diameter of the finished expanded ring. The diameter of the second cylindrical portion 152c is larger than that of the first cylindrical portion 152a and smaller than that of the third cylindrical portion 152e. The diameter of the fourth cylindrical portion 152f is slightly smaller than the diameter of the die chamber 51b. The cylindrical portions 152a, 152c and 152e constitute portions of constant cross-sectional dimensions as well as any necessary clearance gaps; the conical portions 152b and 152d each form a transition portion between the portions of constant cross-sectional dimensions.

FIG. 6 shows the die 51 with the ring 41 being expanded inserted into the die chamber 51b and the expansion punch 152 in a position in which only the first cylindrical portion 152a has been inserted into the ring 41. By means of a drive (not shown), which is typically a mechanical drive, the expansion punch 152 is then pressed fully into the ring 41 until it finally assumes the position shown in FIG. 7, the ring 41 thereby being expanded to its final form. The finished expanded ring is again indicated by reference sign R in FIG. 7. As described above in connection with the third cylindrical portion 52d of the expansion punch 52, the fourth cylindrical portion 152f of the expansion punch 152 serves for the coining of the expanded ring R.

It will be understood that the expansion can also be effected in more than two steps, in which case an expansion punch having a correspondingly larger number of stepped cylindrical portions would be used. In all cases the expansion punches can have lead-in chamfers and clearance gaps.

In the described embodiment of FIGS. 5 to 7, the expansion and the coining are effected using the same tool, that is to say the expansion punch 152. FIGS. 8 to 12 and FIGS. 13 to 17 show two variants of the method in which the expansion is effected using a first tool and the coining is effected using a separate second tool.

The variant of FIGS. 8 to 12 corresponds in principle to the variant of FIGS. 2 to 4 except that here an expansion punch 252 (FIG. 8) has been used which has substantially the same configuration as the expansion punch 52 (FIG. 2) but lacks the third cylindrical portion 52d of the expansion punch 52. FIGS. 9 and 10 show how the expansion punch 252 is pressed into the ring 41 being expanded. After the expansion operation, the expansion punch 252 is removed and the coining of the expanded ring R is carried out by means of a dedicated coining punch 253 (FIGS. 11 and 12). The coining punch 253 comprises a first cylindrical portion 253a and a second cylindrical portion 253b. The two portions 253a and 253b correspond to the cylindrical portions 52c and 52d of the expansion punch 52 of FIG. 2.

The embodiment according to the invention of FIGS. 13 to 17 corresponds in principle to the variant of FIGS. 5 to 7 except that here an expansion punch 352 (FIG. 13) has been used which has substantially the same configuration as the multiply stepped expansion punch 152 (FIG. 5) but lacks the fourth cylindrical portion 152f of the expansion punch 152. FIGS. 14 and 15 show how the expansion punch 352 is pressed into the ring 41 being expanded. After the expansion operation, the expansion punch 352 is removed and the coining of the expanded ring R is carried out by means of a dedicated coining punch 353 (FIGS. 16 and 17). The coining punch 353 comprises a first cylindrical portion 353a and a second cylindrical portion 353b. The two portions 353a and 353b correspond to the cylindrical portions 152e and 152f of the expansion punch 152 of FIG. 5. This variant according to the invention differs from the variant of FIGS. 8 to 12 by the use of a multiply stepped expansion punch 352.

FIGS. 18 to 23 show a further variant of the method according to the invention wherein the expansion of the ring 41 is carried out in two successive steps or phases. Each of the two phases, which are identical in procedure, corresponds to the variant of the method illustrated in FIGS. 2 to 4 using the forming tools (dies and expansion punches) used therein, but the dies and the expansion punches in the two phases have different dimensions. In the first phase (FIGS. 18 to 20), a first die 451 and a first expansion punch 452 are used. The first die 451 has a first die chamber 451b, the diameter of which is smaller than the desired external diameter of the finished expanded ring. Accordingly the expansion punch 452 is also slightly smaller in its diameters. In this phase, therefore, from the ring 41 there is first produced a ring 141 which does not yet have the desired dimensions of the finished expanded ring. In the second phase (FIGS. 21 to 23), a second die 551 and a second expansion punch 552 are used. The second die 551 has a second die chamber 551b, the diameter of which corresponds to the desired external diameter of the finished expanded ring. Accordingly the expansion punch 552 is also slightly larger in its diameters. In this phase the ring 141 is expanded to the desired dimensions of the finished ring R and coined.

In terms of the device, this variant is implemented so that the expansion stage comprises two sub-expansion stages each having a die 451 and 551 and an associated expansion punch 452 and 552, respectively.

FIGS. 24 to 27 illustrate a further variant of the method which substantially corresponds to the variant of FIGS. 2 to 4 but which, instead of starting from a cylindrical ring 41, starts from a ring 241 having two portions 241a and 241b of different external and internal diameters (FIG. 24). The production of this ring 241 is again effected in a manner known per se in the forming stages 10-40 of the forming device 100.

The larger-diameter portion 241b of the ring 241 already has the dimensions of the finished expanded ring. Accordingly, only the smaller-diameter portion 241a of the ring 241 and the transition region to the larger portion 241b needs to be expanded. FIG. 26 shows how the expansion punch 52 is inserted into the ring 241, and FIG. 27 shows the expansion punch 52 in the state in which it has been fully inserted into the die; again the coining of the finished expanded ring R also takes place at the same time.

The method according to the invention described above and the corresponding device according to the invention are suitable especially for producing rolling bearing rings from rolling bearing steel. The forming in the individual forming stages is effected in hot-forming processes in a temperature range of about 700° C. and above. The integration of the expansion operation directly into the forming device makes it possible for the thermal energy absorbed during the forming process to be utilised for the expansion. Depending upon the material, the forming and especially the expansion can also take place in the cold state.

1. A method for producing a ring-shaped formed part, in which by means of a forming device a ring of smaller cross-sectional dimensions than the formed part being produced is formed from a blank and then, in an expansion stage of the forming device, the resulting ring is expanded to the cross-sectional dimensions of the formed part being produced by means of at least one die and by means of at least one expansion punch, wherein the ring is arranged in the die and the expansion punch is pressed into the ring in the axial direction and thereby expands the ring, wherein the expansion of the ring is effected in two or more steps.

2. The method according to claim 1, wherein the expansion punch is used which has at least two portions of different cross-sectional dimensions and a transition portion between each two such portions.

3. The method according to claim 1, wherein the die comprises a die chamber for receiving the ring, wherein the cross-sectional dimensions of the die chamber correspond to the external cross-sectional dimensions of the formed part being produced.

4. The method according to claim 1, wherein the expansion of the ring is effected by means of two or more dies of different dimensions and accordingly by means of two or more expansion punches of different dimensions.

5. The method according to claim 1, wherein the expansion of the ring is effected by means of the expansion punch which is doubly or multiply stepped in its cross-sectional dimensions.

6. The method according to claim 1, wherein the expansion is followed by a coining step, wherein the expanded ring is acted upon in the die by pressure in the axial direction by means of a portion of the expansion punch or by means of a separate coining punch.

7. The method according to claim 1, wherein the formed part being produced is a rolling bearing ring.

8. The method according to claim 1, wherein the forming of the blank into the ring is effected by hot-forming at temperatures of 700° C. and above.

9. A device for producing a ring-shaped formed part using a forming device comprising forming stages which are configured to form a ring from a blank, and having an expansion stage which has at least one die for receiving the ring and at least one expansion punch which is arranged to be pressed axially into the ring located in the die, the ring being expandable in the die by the expansion punch, wherein the expansion stage is configured to carry out the expansion of the ring in two or more steps.

10. The device according to claim 9, wherein the expansion punch has at least two portions of different cross-sectional dimensions and a transition portion between each two such portions.

11. The device according to claim 9, wherein the expansion stage has two or more dies of different dimensions and accordingly two or more expansion punches of different dimensions.

12. The device according to claim 9, wherein the at least one expansion punch is doubly or multiply stepped.

13. The device according to claim 10, wherein the expansion stage has two or more dies of different dimensions and accordingly two or more expansion punches of different dimensions.

14. The device according to claim 10, wherein the at least one expansion punch is doubly or multiply stepped.

15. The device according to claim 11, wherein the at least one expansion punch is doubly or multiply stepped.

16. The method according to claim 2, wherein the die comprises a die chamber for receiving the ring, wherein the cross-sectional dimensions of the die chamber correspond to the external cross-sectional dimensions of the formed part being produced.

17. The method according to claim 2, wherein the expansion of the ring is effected by means of two or more dies of different dimensions and accordingly by means of two or more expansion punches of different dimensions.

18. The method according to claim 3, wherein the expansion of the ring is effected by means of two or more dies of different dimensions and accordingly by means of two or more expansion punches of different dimensions.

19. The method according to claim 2, wherein the expansion of the ring is effected by means of the expansion punch which is doubly or multiply stepped in its cross-sectional dimensions.

20. The method according to claim 3, wherein the expansion of the ring is effected by means of the expansion punch which is doubly or multiply stepped in its cross-sectional dimensions.
